(19) United States
(12) Patent Application Publication
(10) Pub. No.: US 2012/0181409 A1
(43) Pub. Date: Jul. 19, 2012

(54) VEHICLE SLIDE RAIL APPARATUS

(75) Inventors: Hiroaki Hayahara, Seto-Shi (JP); Kouhei Izuchi, Toyokawa-shi (JP)

(73) Assignees: SHIROKI CORPORATION, Kanagawa-ken (JP); TOYOTA BOSHOKU KABUSHIKI KAISHA, Aichi-ken (JP)

(21) Appl. No.: 13/391,008

(22) PCT Filed: Aug. 6, 2010
(86) PCT No.: PCT/JP2010/063361

§ 371 Date: Mar. 30, 2012

(30) Foreign Application Priority Data
Aug. 20, 2009 (JP) 2009-191075

(51) Int. Cl. B60N 2/07

(52) U.S. Cl. 248/429

(57) ABSTRACT

A slide rail has an opening allowing insertion and extraction of a slider. The slide rail has an opening. The cover member has an opening which overlaps opening. An open side corner surface of an inner peripheral edge portion of the opening of the slide rail is formed such that it has a rounded configuration. The inner peripheral edge portion with the rounded configuration is formed so as to extend in the direction of the center of the opening and beyond the opening of the cover member.

### BACKGROUND OF THE INVENTION

Embodiments of the present invention relate to a vehicle slide rail apparatus. More specifically, embodiments of the present invention relate to a vehicle slide rail apparatus which has a slide rail in the form of an elongated frame. They may have an opening slit allowing exposure of a slider and a cover member covering the opening slit from the outside.

### DESCRIPTION OF THE RELATED ART

A slide rail for use on a vehicle floor is known in the art. A slide rail may be configured to guide the movement of a slider and may be equipped with a functional component such as a hook. The specification of Laid-Open US Patent Application No. 2007/0041804 discloses a plurality of engagement teeth longitudinally formed on a slide rail for slide-locking a slider. In this disclosure, the slide rail is formed through lateral press bending of an elongated steel plate onto a rectangular frame.

A space is formed at a mating portion at the center of one side of the rectangular frame. Here, bent end portions are matched with each other. An opening slit allows exposure of a slider. The opening slit extends in the longitudinal direction. Engagement teeth with alternately formed crests and troughs may be provided at the edges of the two bent portions of the opening slit. The slider can be slide-locked through engagement of the engagement teeth.

In order to prevent exposure of the engagement teeth within the opening slit, the slide rail is covered with a cover member covering the engagement teeth. This cover member is provided so as to cover the slide rail over its entire longitudinal area. Like the slide rail, the cover member has an opening slit so that the opening slit of the slide rail may be exposed to the exterior.

A slider may be inserted at one side of the above-mentioned slide rail. After insertion, caps are attached to end portions of the slide rail, whereby detachment of the slider from the slide rail is prohibited. In view of this, there is partially provided, on the side of the rectangular frame of the slide rail with the opening slit, a wide opening for allowing detachment of the slider. Through this arrangement it is possible to freely insert and extract the slider via the opening.

### SUMMARY OF THE INVENTION

When the opening is provided in a slide rail, it is also generally necessary to form an opening in the cover member through cutting or the like. In such an arrangement, luggage or other stowed items may get caught on the cut portion. During manufacture, the cut portion is created with an undesirable rough profile.

Embodiments of the invention have been made with a view towards solving the above problem. It is an object of embodiments of the present invention to improve constructions having an opening that allow insertion and extraction of a slider. It is desired to also provide a cover member covering this slide rail and an opening that reduces or removes the possibility of snagging stowed luggage or other objects.

A vehicle slide rail apparatus according to embodiments of the present invention preferably have an elongated frame-like slide rail. On one side an opening slit allows exposure of a slider to the exterior. A cover member may be attached to the slide rail apparatus on the side where the slit is formed. On its one side where the opening slit is formed, the slide rail has an opening allowing insertion and extraction of the slider in the region where the opening of the slide rail is formed. The cover member has an opening overlapping the above-mentioned opening. The opening of the slide rail has an inner peripheral edge portion. The inner peripheral edge portion has an open side corner surface with a rounded configuration. This peripheral inner edge extends toward the center of the opening and beyond the opening of the cover member.

In embodiments of the present invention, the outwardly open side corner surface of the inner peripheral edge portion of the opening formed in the slide rail is rounded. The inner peripheral edge portion with this rounded corner surface is provided so as to protrude further toward the center side than the opening of the cover member. This construction is particularly useful when the opening of the cover member is formed through cutting or the like and results in a rather rough profile. The inner peripheral edge portion with the rounded corner surface of the slide rail opening constitutes a surface portion protruding substantially to the innermost side of the opening. Thus, it is possible to provide a cover member covering this slide rail with a reduced possibility of snagging luggage or other stowed items in a vehicle.

Further, embodiments of the present invention also may allow the following construction: rounded corner surfaces of the outwardly open side of the inner peripheral edge portion of the opening of the slide rail may be formed through shear droop. Shear droop on the outwardly open side corner surface may be formed by stamping.

In certain embodiments of the invention, the rounded configuration on the corner surface on the outwardly open side of the inner peripheral edge portion of the opening of the slide rail is formed as a rounded configuration due to shear droop. The rounded configuration is easily accomplished through stamping of the opening of the slide rail.

Further, embodiments of the present invention may also adopt the following construction: at the one side of the slide rail having the opening slit, a plurality of engagement teeth may be formed in a longitudinal direction for slide-locking the slider. These engagement teeth would be formed so as to extend into the opening slit. The opening of the slide rail is formed to extend from a longitudinal end surface portion of an engagement member on which the engagement teeth are formed. The corner portion of this longitudinal end surface portion may be rounded.

In embodiments of the invention, the opening of the slide rail is formed to extend from a longitudinal end surface portion of an engagement member on which the engagement teeth are formed. The corner portion of this end surface portion may be rounded. The rounded corner portion of the engagement member is formed so as to extend toward the opening center side beyond the corner portion of the opening formed in the cover member. In such a fashion, even when the opening of the cover member is formed with a rough edge, it is possible to prevent objects from being caught by the rough corner portion.

### BRIEF DESCRIPTION OF DRAWINGS

FIG. 1 is a perspective view, as seen from the rear side, of a vehicle seat in a seated state;

FIG. 2 is a perspective view of the vehicle seat in an accommodated state;

FIG. 3 is an exploded perspective view of a frame structure of an interior of the vehicle seat;

FIG. 4 is a perspective view of the frame structure of FIG. 3 as assembled;

FIG. 5 is an exploded perspective view of a vehicle slide rail apparatus;

FIG. 6 is a plan view of the vehicle slide rail apparatus as assembled;

FIG. 7 is a sectional view taken along the line VII-VII of FIG. 4; and

FIG. 8 is a partial sectional view illustrating an engagement lock structure for a slider with respect to a slide rail.

### DETAILED DESCRIPTION OF THE INVENTION

Embodiments of the present invention will be illustrated with reference to the drawings.

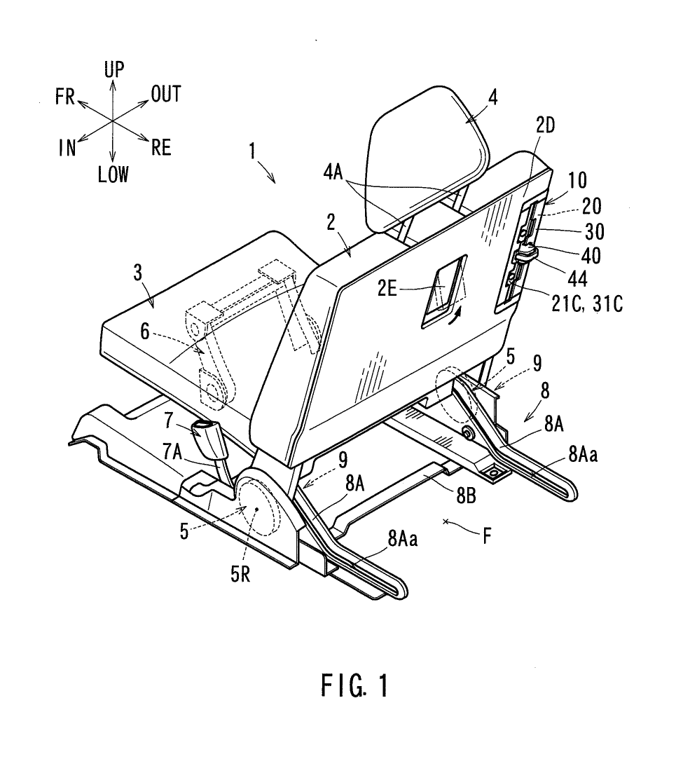

An embodiment of a vehicle slide rail apparatus 10 will be described with reference to FIGS. 1 to 8. FIG. 1 illustrates the construction of a vehicle seat 1 on which the vehicle slide rail apparatus 10 is mounted. The vehicle seat 1 may be used in a vehicle of any type in the vehicle, for example, may be used as a rear row seat in a vehicle with 3 rows of seats, it has a front, middle, or rear row seats. The vehicle seat 1 may be equipped with a seat back 2 serving as a backrest for a seated occupant, a seat cushion 3 constituting a seating portion and a headrest 4.

In the figures, the vehicle seat 1 is exemplified as being in the third row of seats in a vehicle. The seat is arranged on the right-hand side of the vehicle as one views the interior of the vehicle from the rear of the vehicle. To the right of the vehicle seat 1 (as viewed from the rear of the vehicle) the vehicle sidewall would normally exist. The right side is the outer side of the seat. To the left of the vehicle seat 1 (as viewed from the rear of the vehicle) another seat would typically exist. The left side is the inner side of the seat.

Seat 1 has a seat back 2 and a seat cushion 3, which are connected to and supported by a base frame 8 fixedly installed on a vehicle floor F, with a headrest 4 being connected to and supported on the upper portion of the seat back 2. Each of the lower end portions of the right and left sides of the seat back 2 may be connected to the base frame 8 via a disc-type reclining device 5. The reclining device 5 functions as a shaft of the rotation of the seat back 2 and as a stopper of the rotation.

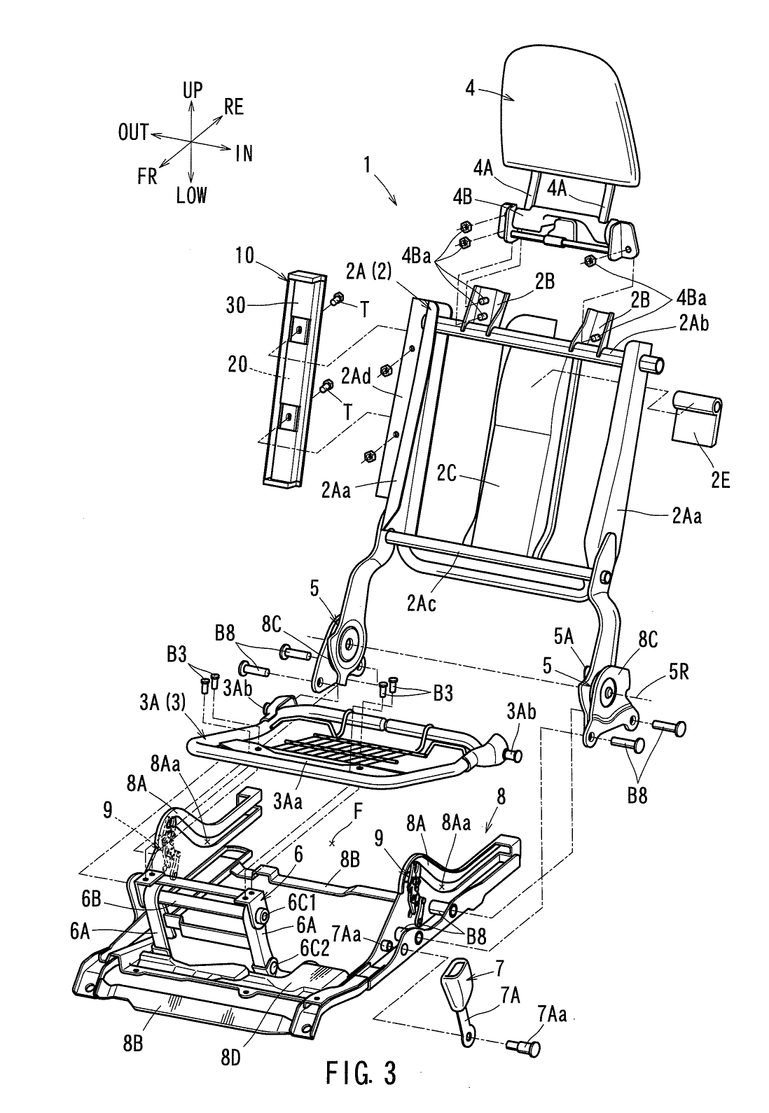

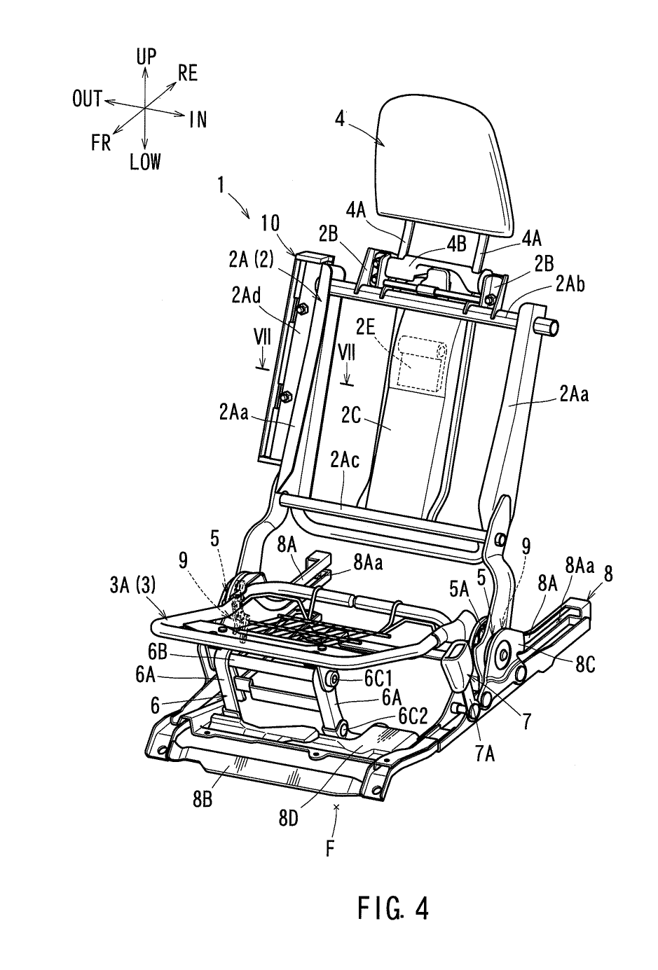

As shown in FIGS. 3 and 4, the base frame 8 may be formed by a pair of right and left base plates 8A elongated in the longitudinal direction of the vehicle. These base plates 8A are provided so as to be integrally fastened to the floor F by fastening members. Exemplary fastening members may include bolts and nuts (not shown). Front and rear portions of the base plates 8A may be integrally connected to each other by a plurality of laterally elongated thin connection plates 8B. The connection plates 8B may also be integrally fastened to the floor F by fastening members.

The seat back 2 may include a back frame 2A constructed of a pair of right and left side frames 2Aa formed of steel plates elongated in the vertical direction. It may also include an upper pipe 2Ab and a lower pipe 2Ac for connecting the upper end portions and the lower end portions of the side frames 2Aa to each other. The upper pipe 2Ab and lower pipe 2Ac may preferably be constructed of steel. In the seat back 2, the lower end portions of the side frames 2Aa may be connected to the base plates 8A via the reclining devices 5.

The side frames 2Aa on both sides of the seat back 2 may be connected to stationary brackets 8C. The side frames 2Aa are preferably integrally and fixedly connected to the base plates 8A on both side of the base frame 8. Stationary brackets 8C may be respectively connected to the base plates 8A by fastening members B8. On the inner side base plate 8A there may be provided a support plate 7A of a seatbelt buckle 7 constituting a seatbelt attachment apparatus (not shown) so as to be integrally attached by fastening members 7Aa.

In the headrest 4, a hinge bracket 4B equipped with a rotary hinge structure may be integrally connected to lower end portions of bar-like stays 4A. Hinge bracket 4B may also be integrally connected to stationary brackets 2B connected by fastening members 4Ba. The stationary brackets 2B may be connected to the upper pipe 2Ab of the back frame 2A. The headrest 4 is disposed at the upper portion of the seat back 2.

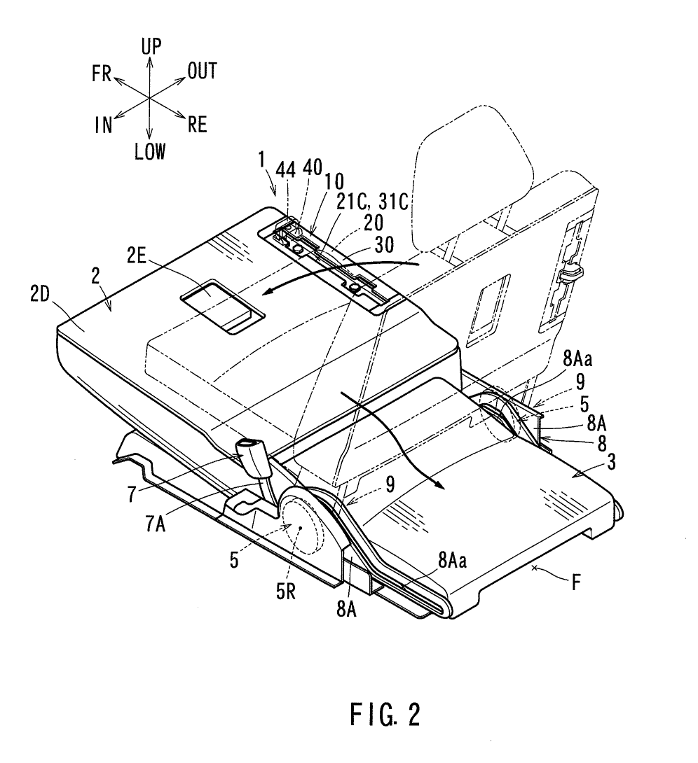

In the headrest 4, the rotary hinge structure of the hinge bracket 4B is normally locked whereby it cannot be rotated. A main body portion which receives the head of the occupant is in a state where it protrudes upwards beyond the seat back 2. By pulling on an operation lever 2E provided on the back surface portion of the seat back 2, the rotation-lock of the rotary hinge structure of the hinge bracket 4B may be released. Upon release, the main body portion of the headrest 4 may be rotated forward and downward around a rotation hinge shaft (not shown) of the hinge bracket 4B. The headrest 4, along with the stays 4A may be folded onto the backrest surface side of the seat back 2 (See FIG. 2).

As shown in FIGS. 3 and 4, the operation lever 2E serves to operate the hinge bracket 4B. A mechanism for releasing the locked state of the rotary hinge bracket 4B would preferably be located on a central bracket 2C. This central bracket 2C may be formed of a steel plate bridging between the upper pipe 2Ab and the lower pipe 2Ac of the back frame 2A. The mechanism for releasing the locked state is not shown in the figures. An operation lever 2E may be rotatably connected to the back side surface of the central bracket 2C.

The inner side reclining device 5 (i.e., on the right-hand side as seen in FIGS. 3 and 4) is formed as a rotary shaft device with a rotation stopping function. The outer reclining device 5 (i.e. on the left-hand side as seen in FIGS. 3 and 4) does not have a rotation-stopping function. Instead, it simply functions as a rotary shaft device. The inner side reclining device 5 is normally maintained in a rotationally-stopped state. As shown in FIG. 1, pulling-up on the operation lever 2E on the back surface portion of the seat back 2 activates a releasing lever 5A connected to the reclining device 5 whereby the rotationally-stopped state is unlocked.

Operation lever 2E serves to operate the releasing lever 5A of the reclining device 5. The construction of these parts is preferably composed of a cable-pulley structure not shown in the figures. The seat back 2 is normally maintained in an erect state in which the occupant can use it as a backrest by locking the inner side of the reclining device 5. Through the pulling of the operation lever 2E, the locked state of the seat back 2 is released whereby the seat back 2 may be rotated forward and downward around a rotation center 5R. The rotation center 5R is coaxial with centers of the reclining devices 5.

Between the seat back 2 and the base frame 8, there may exist an urging spring (not shown) serving to tilt the seat back 2 forward. Through pulling of the operation lever 2E, the locked state of the seat back 2 is released, whereby the seat back 2 may be tilted forward until it lies generally prostrate on the floor F due to the urging force of the urging spring (not shown) (See FIG. 2).

Next, referring back to FIGS. 3 and 4, the construction of the seat cushion 3 will be described. A cushion frame 3A, constituting the framework of the seat cushion 3, may be assembled into a rectangular frame using steel pipes. Side portions on the front end side of the cushion frame 3A may be rotatably connected to the base frame 8 via a front link 6.

The front link 6 may have a pair of right and left link members 6A in the form of elongated plates integrally connected to each other by a rod 6B. In the front link 6, rotary hinge portions 6C1 rotatably formed at the upper end portions of the link members 6A may be set on mounting seat portions 3Aa formed on both side portions on the front end side of the cushion frame 3A. They may be connected by fastening members such that the front link 6 may be rotated at the rotary hinge portions 6C1.

In the front link 6, rotary hinge portions 6C2 formed at the lower end portions of the link members 6A are respectively set on a support bracket 8D provided so as to bridge between the two base plates 8A of the base frame 8. The rotary hinge portions 6C2 may be fastened by fastening members consisting of bolts and nuts (not shown), whereby the front link 6 may be rotated at the hinge portions 6C2.

The support bracket 8D consists of a laterally elongated plate member, whose right and left end portions are integrally and fixedly connected to the base plates 8A on both sides. The support bracket 8D itself may also integrally and fixedly connected to the floor F by fastening members (not shown). Slide pins 3Ab respectively protruding toward outer sides of the cushion frame 3A may be attached to side portions at the rear end side of the cushion frame 3A of the seat cushion 3.

Slide pins 3Ab may be inserted into rail holes 8Aa formed to extend through the base plate 8A. They may be slid in the longitudinal direction of the rail holes 8Aa. As the front link 6 rotates to fall forward via the rotary hinge portions 6C2, the slide pins 3Ab slide within the rail holes 8Aa toward the front end side. As the front link 6 rotates to fall backwards, the slide pins 3Ab slide within the rail holes 8Aa toward the rear end side.

The forward falling rotation of the front link 6 stops at a position where the slide pins 3Ab abut the front end portions of the rail holes 8Aa to be thereby locked. At this rotation-stopped position, the seat cushion 3 is maintained in the state in which it is normally used for seating. Cushion lock devices 9 function to hold the seat cushion 3 in a seated position by locking slide pins 3Ab.

The cushion lock devices 9 are operated by the movement of the slide pins 3Ab. When the slide pins 3Ab reach the front end portions of the rail holes they become locked at the front end portions of the rail holes 8Aa. The cushion lock devices 9 are unlocked by pulling up on the operation lever 2E on the back surface portion of the seat back 2. The slide pins 3Ab are also unlocked by pulling up on the operation lever 2E.

As the front link 6 rotates to fall backwards, the slide pins 3Ab slide within the rail holes 8Aa toward the rear side. The front end portions of the rail holes 8Aa may be set to be higher than the rear end portions, forming slide-like slopes inclined from the front end portions toward the rear end portions on both sides.

The front link 6 rotates to fall backwards, the slide pins 3Ab slide smoothly toward the rear side while slipping down on the slopes of the rail holes 8Aa to smoothly effect the movement toward the rear side of the seat cushion 3. Between the seat cushion 3 and the base frame 8, there may be a biasing spring (not shown) configured to constantly bias the seat cushion 3 to move toward the rear.

Through pulling up on the operation lever 2E as described above, the slide pins 3Ab are unlocked, whereby the seat cushion 3 may be moved toward the vehicle rear side by the biasing force of the biasing spring (not shown). The seat back 2 falls forward towards the space in which the seat cushion 3 previously existed. The seat cushion 3 moves rearward to allow room for the seat back 2. The seat back 2 is moved to a position where it generally lays flush against the edge of the seat cushion and generally parallel to the floor F.

On the back of the seat back 2, there is provided a backboard 2D in the form of a hard plate so as to extend over its entire surface. When the seat back 2 falls forward it can function as a surface for placing luggage or other objects in the vehicle. As shown in FIG. 1a vehicle slide rail apparatus 10 may exist on the back surface portion of the seat back 2. The apparatus 10 is elongated in the height direction along the edge portion of the outer side portion of the seat back 2.

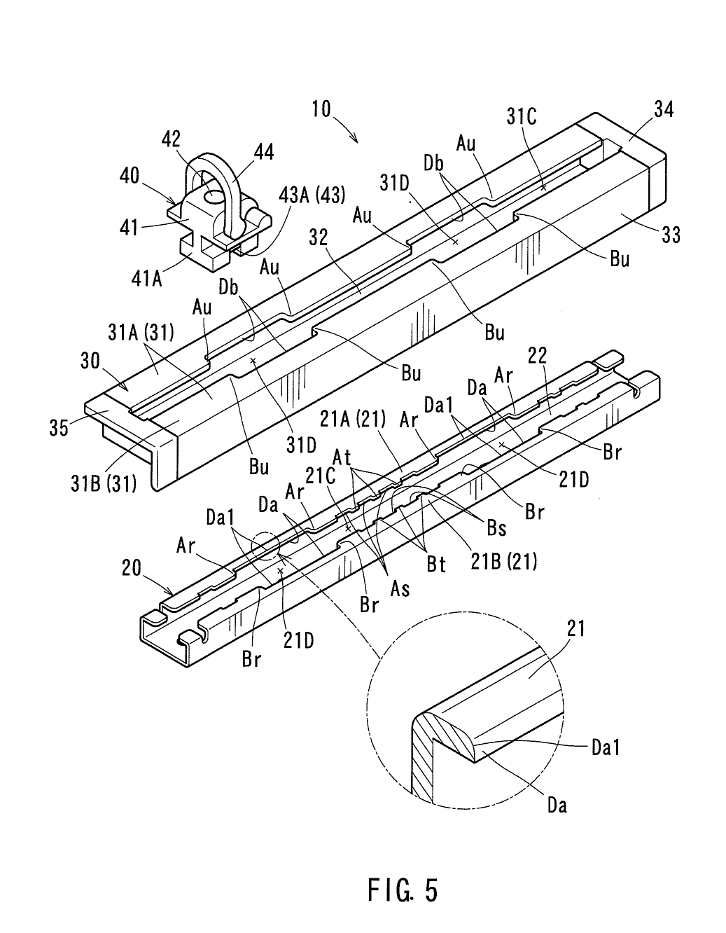

As shown in FIG. 5, this vehicle slide rail apparatus 10 may be equipped with an elongated slide rail 20 and a cover member 30 covering the surface layer portion of the slide rail 20. It is possible to attach a slider 40 to the slide rail 20. The slider 40 is equipped with a hook 44 serving as an engagement member. The hook 44 may be used to assist in the fastening of cargo to the vehicle. The construction of the slide rail 20, the cover member 30 and the slider 40 will be described in detail.

First, the construction of the slide rail 20 will be described. As shown in FIG. 5, the slide rail 20 is formed by bending an elongated steel plate in the lateral direction into a rectangular frame. The bent end portions face each other. There is provided a space between these end portions. An elongated opening slit 21C is formed at the center of the rectangular frame. The slider 40 may be exposed through this elongated opening slot 21C.

The slide rail 20 is formed so as to possess a top plate portion 21 having at its center the opening slit 21C extending in the longitudinal direction. This top plate portion exists at one side of the rectangular frame where the bent end portions of the steel plate meet each other. As shown in FIG. 1, the slide rail 20 may be embedded in the seat back 2 such that its rail contour does not protrude from the back surface portion of the seat back 2. The opening slit 21C is formed in the top plate portion 21 and exposed in the back of the seat back 2.

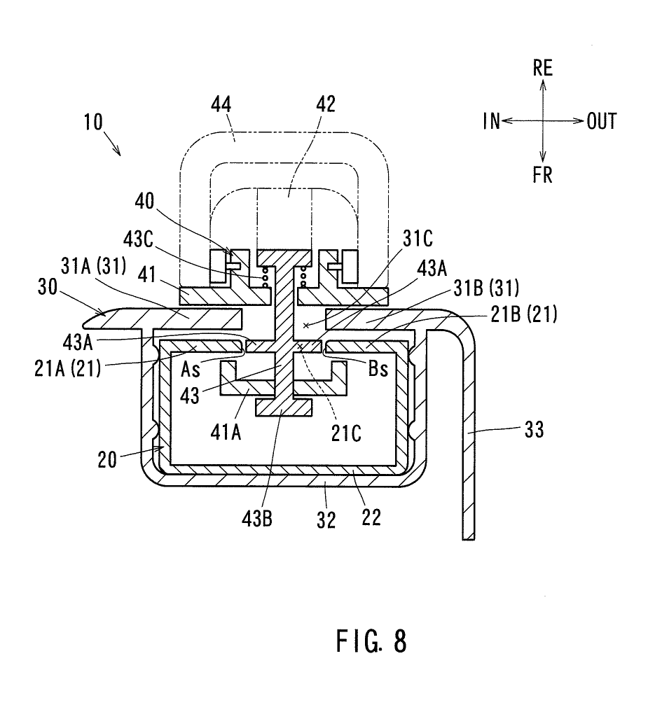

Referring to FIG. 5, engagement members 21A and 21B are formed on the top plate portion 21 of the slide rail. Engagement teeth At and Bt are formed on the inner edges of engagement members 21A and 21B. The engagement teeth At and Bt are undulating toward the opening slit 21C, with crests and troughs being alternately formed in the longitudinal direction. With reference to FIG. 8, lock claws 43A constituting the slider 40 are pushed from within the slide rail 20 toward the top plate portion 21 through biasing to enter any of tooth grooves As and Bs between the engagement teeth At and Bt. The engagement teeth At and Bt serve to hold the slider 40 in a locked state.

As shown in FIG. 5, at two longitudinal positions of the top plate portion 21 of the slide rail 20, there are formed rectangular openings 21D serving as inlet/outlet openings allowing the slider 40 to be inserted into and removed from the slide rail 20. These openings 21D are formed through partial enlarging of the inwardly facing edge portions of the engagement members 21A and 21B. The opening slit 21C is partially enlarged.

The slide rail 20 is formed into a rectangular frame through press bending. Prior to press bending, the openings are preferably formed through stamping. Through stamping, rounded configurations Da1 are formed. Rounded portions Da1 with a shear droop are formed on the outwardly open side of the inner peripheral edge portions Da of the openings 21D. Rounded portions with a shear droop are formed on the corner surfaces on the outwardly open side of the inner edge portions of the engagement members 21A and 21B. The engagement members 21A and 21B face each other.

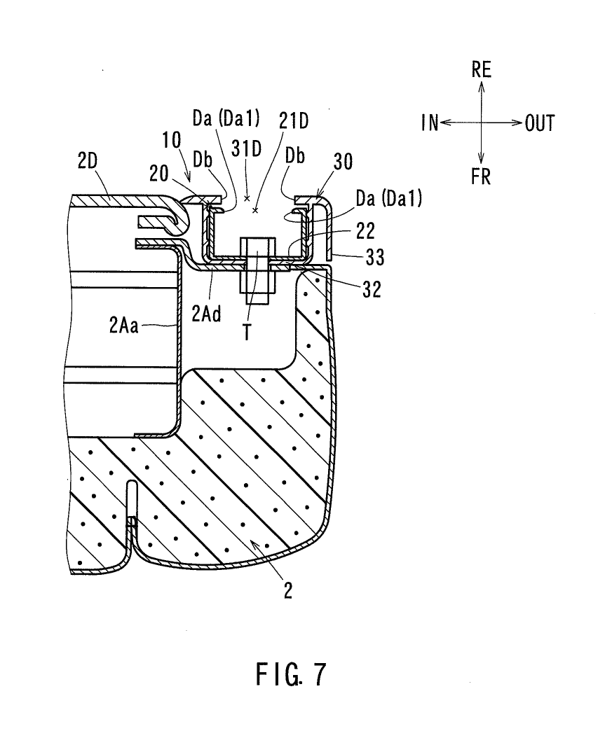

Next, referring back to FIG. 5, the construction of the cover member 30 will be described. This cover member 30 is formed through extrusion molding of an aluminum alloy plate into an elongated rail frame. In FIG. 7, the cover member 30 is formed as a rectangular frame whose cross-sectional size can cover the entire outer peripheral portion of the slide rail 20. This cover member 30 has an opening slit 31C extending over its longitudinal area. It allows for the opening slit 21C formed in the top plate portion 21 of the slide rail 20 to be exposed to the exterior.

In the top plate portion 31 of the cover member 30, there are rectangular openings 31D so that openings 21D formed in the top plate portion 21 of the slide rail 20 are exposed to the exterior. These openings 31D are formed through cutting of the inwardly directed edge portions of both top plate members 31A and 31B. An opening slit 31C forms the top plate portion 31. As compared with the inner peripheral edge portions Da of the openings 21D of the slide rail 20, the inner peripheral surfaces of the inner peripheral edge portions Db of the openings 31D are finished so as to exhibit relatively high surface roughness.

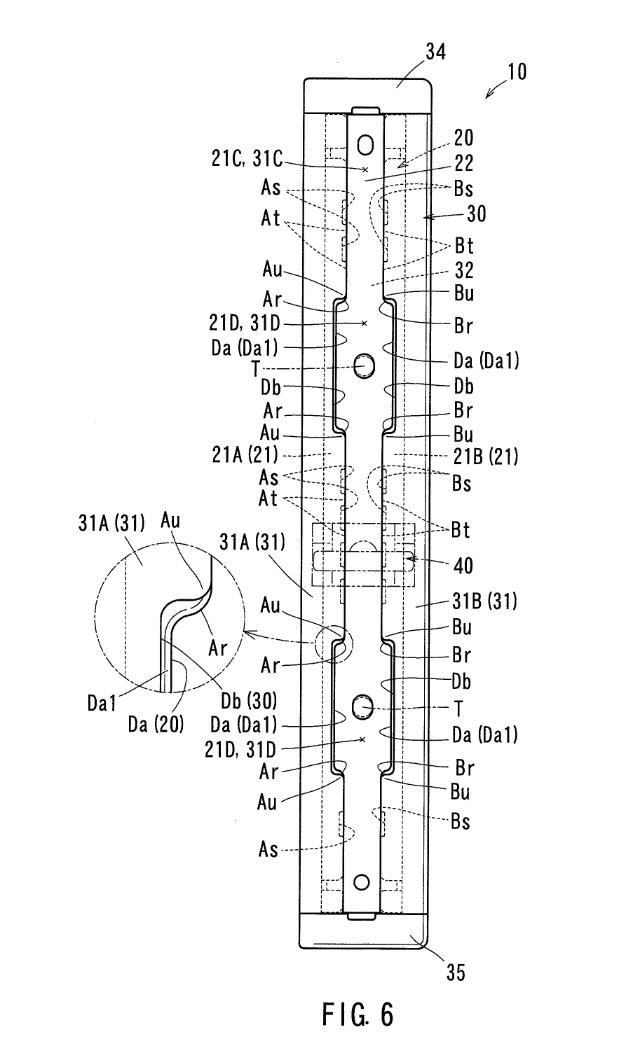

As shown in FIG. 6, the openings 31D of the cover member 30 finished in high surface roughness are formed wider than the openings 21D formed in the slide rail 20. When the cover member 30 is superimposed over the slide rail 20, the openings 31D and 21D resultantly lay one over the other. The inner peripheral edge portions Da of the openings 21D formed in the slide rail 20 protrude further toward the opening than the inner peripheral edge portions Db of the openings 31D of the cover member 30.

The inner peripheral edge portions Da of the openings 21D of the slide rail 20 exhibit rounded configurations Dal at the corner surfaces. These peripheral edge portions Da constitute the surface portions protruding substantially to the inner side. While, the inner peripheral edge portions Db of the cover member 30 are formed in rather rough surface finish. In such a manner, objects are prevented from being snagged by the inner peripheral edge portions Db. Resultantly, it is possible to insert and remove the slider 40 via the opening windows formed by superimposing the openings 21D and 31D upon each other.

As shown in FIG. 6, the openings 21D have rounded corner portions Ar and Br at the end surface portions of the engagement members 21A and 21B. These rounded corner portions Ar and Br extend further toward the opening than edge corner portions Au and Bu. Thus, no edge contour protrudes into the openings 21D thereby improving the usability of the openings 21D.

As shown in FIG. 7, the bottom plate portions 22 and 32 of the slide rail 20 and the cover member 30 may be superimposed on each other. They can be fastened to a plate-like mounting bracket 2Ad bonded to the side frame 2Aa by using fastening bolts T. The side frame 2Aa lies on the outer side portion of the seat back 2. In this manner, bottom plate portions 22 and 32 may be fixed to the side frame 2Aa. As shown in FIG. 6, opening windows are formed through superimposition of the openings 21D formed in the slide rail 20 and the openings 31D formed in the cover member 30. Fasteners, such as fastening bolts T, may be positioned at these opening windows for fastening the bottom plate portions 22 and 32.

Fastening the fastening bolts T can be easily performed by inserting the bolts into the opening windows and inserting, for example, a fastening tool to tighten the bolts. As shown in FIG. 7, the cover member 30 is arranged such that the top plate portion 31 is put on the top plate portion 21 of the slide rail 20 and is flush with the back surface portion of the seat back 2. A fin portion 33, is formed so as to extend from the edge portion of the outer side portion of the top plate portion 31 toward the front side of the seat back 2. The fin portion 33 may cover the back surface portion and the side surface portions. The fin portion 33 forms the corner portion of the outer side portion of the seat back 2.

The design surface constitutes the contour of the back surface portion. The side surface portion constitutes the corner portion of the outer side portion of the seat back 2. The design surface of the side surface portion may be formed as one continuous whole. Referring to FIG. 5, caps 34 and 35 preventing detachment of the slider 40 may be attached to the open end portions of the cover member 30. These caps 34 and 35 are attached so as to be fitted with the open end portions of the cover member 30 and the open end portions of the slide rail 20. They are preferably fitted to prevent detachment of the slider 40 from the open end portions on each side.

Next, the construction of the slider 40 will be described with reference to FIGS. 5 and 8. The slider 40 may be equipped with a main body portion 41 configured to be engaged with the top plate portion 21 of the slide rail 20, a pushbutton 42 provided on the main body portion 41, a movable portion 43 to be depressed by the pushbutton 42, and a hook 44 rotatably hinge-connected to the main body portion 41. The main body portion 41 may have a protrusion-plate-like bottom plate portion 41A formed at the bottom portion constituting an insertion portion. This bottom plate portion 41A may be inserted into the rail frame via opening 21D of the slide rail 20, to set the main body portion 41 in position. In this state, the main body portion 41 may slide in the longitudinal direction of the slide rail 20, whereby the bottom plate portion 41A is held against the rail frame inner side surfaces of the two engagement members 21A and 21B to be thereby prevented from detachment. In this state, the main body portion 41 is allowed to slide through the opening slit 21C.

The pushbutton 42 is mounted to the portion of the main body portion 41 on the side exposed to the exterior of the slide rail 20. By pushing the pushbutton 42 toward the interior of the rail frame of the slide rail 20, the movable portion 43 is pushed down, whereby the movable portion 43 is detached from the engagement with the top plate portion 21 of the slide rail 20. The movable portion 43 may be integrally attached to the pushbutton 42. The lock claws enter tooth grooves As and Bs between engagement teeth At and Bt formed on the top plate portion 21. A compression spring 43C lies between the moveable portion 43 and the main body portion 41. The biasing force of the compression spring 43C normally causes the lock claws 43A to enter the rail frame of the slide rail 20.

Through the sliding of the slider 40, the lock claws 43A of the movable portion 43 are caused to enter the tooth grooves As and Bs by the biasing force. The slider may be maintained in a slide lock state due to the fact that the lock claws 43A of the movable portion 43 are matched in arrangement with the tooth grooves As and Bs between the engagement teeth At and Bt of the slide rail 20. The biasing movement of the movable portion 43 due to the compression spring 43C is stopped when the protrusion-plate-like stopper 43B formed on the bottom portion of the movable portion 43 abuts the bottom plate portion 41A of the main body portion 41. Through a pushing operation of the pushbutton 42 to push down the movable portion 43, the lock claws 43A are extracted from the tooth grooves As and Bs, whereby the slide lock state of the slider 40 is released.

Embodiments of the present invention, whose mode functioning method has been described above with reference to an embodiment thereof, can be carried out in various other methods. For example, in the above-described embodiment the rounded configurations Da1 are formed through shear droop due to the cutting at the time of stamping. The rounded configurations Da1 is formed on the inner peripheral edge portions Da of the slide rail 20. This roundness may also be formed by using some other machining means such as cutting. However, it is desirable that a machining method be adopted which does not involve an increase in surface roughness at the rounded portions.

Further, the number of openings 21D formed in the slide rail 20 and the cover member 30 may also be one or more. While in the above-described embodiment the openings 21D are formed in a rectangular configuration, it is also possible to adopt some other configuration such as a triangular or a round one.

The vehicle slide rail apparatus in the above-described embodiment is arranged at the back surface portion of the seat back 2. It is contemplated that the vehicle slide apparatus may be used in other positions in the vehicle such as on the vehicle floor panel or on a side wall panel.

1. A vehicle slide rail apparatus comprising:
an elongated frame-like slide rail,
one side of the slide rail having an opening slit allowing exposure of a slider to an exterior;
a cover member being attached to the one side where this opening slit is formed;
wherein the slide rail comprises, on the one side where the opening slit is formed, an opening allowing insertion and extraction of the slider with respect to an inside of the slide rail;
wherein the cover member also comprises, in the region where the opening of the slide rail is formed, an opening overlapping the opening of the slide rail;
wherein an outwardly open side corner surface of the inner peripheral edge portion of the opening of the slide rail is formed in a rounded configuration; and
wherein the inner peripheral edge portion with the rounded corner surface is provided so as to protrude toward the center of the opening beyond the opening of the cover member.

2. The vehicle slide rail apparatus of claim 1, wherein the rounded configuration on the corner surface on the outwardly open side of the inner peripheral edge portion of the opening of the slide rail is formed through shear droop on the outwardly open side corner surface constituting a cut surface formed by cutting through stamping.

3. The vehicle slide rail apparatus of claim 1,
wherein at the one side of the slide rail having the opening slit, there are formed in a longitudinal direction a plurality of engagement teeth for slide-locking the slider so as to extend within the opening slit, and
wherein the opening of the slide rail is formed to extend from a longitudinal end surface portion of an engagement member on which the engagement teeth are formed, with the corner portion of the end surface portion being rounded.
